(19) United States
(12) Patent Application Publication
(10) Pub. No.: US 2026/0193979 A1
(43) Pub. Date: Jul. 9, 2026

(54) FLOW RATE AND RHEOLOGY MEASUREMENT WITH ENHANCED ACCURACY AT LOW FLOW RATES

(71) Applicant: WEATHERFORD TECHNOLOGY HOLDINGS, LLC, HOUSTON, TX (US)

(72) Inventors: Paul R. NORTHAM, Houston, TX (US); Morgan M. PRUITT, Houston, TX (US); Chad WUEST, Houston, TX (US)

(21) Appl. No.: 19/013,898

(22) Filed: Jan. 8, 2025

Related U.S. Application Data
(60) Provisional application No. 63/742,238, filed on Jan. 6, 2025.

(51) Int. Cl. E21B 47/10; G01F 1/88; G01F 25/10

(52) U.S. Cl. CPC E21B 47/10; G01F 1/88; G01F 25/10

(57) ABSTRACT

A flow measurement apparatus for use with a subterranean well can include a main flow passage, a pressure relief valve connected in the main flow passage, a bypass flow passage having an inlet connected to the main flow passage upstream of the pressure relief valve, and an outlet connected to the main flow passage downstream of the pressure relief valve, and a mass flowmeter connected in the bypass flow passage between the inlet and the outlet. A method can include connecting a flow measurement apparatus in a well system, and closing a pressure relief valve of the apparatus in response to a flow rate in the main flow passage being less than a predetermined flow rate level.

### CROSS-REFERENCE TO RELATED APPLICATION

This application claims the benefit of the filing date of U.S. provisional application No. 63/742,238 filed on 6 Jan. 2025. The entire disclosure of this prior application is incorporated herein by this reference in its entirety for all purposes.

### BACKGROUND

This disclosure relates generally to equipment utilized and operations performed in conjunction with a subterranean well and, in an example described below, more particularly provides for enhanced accuracy of flow rate and rheology measurements at relatively low flow rates.

In certain well operations, such as managed pressure drilling, accurately measuring volumetric and mass flow rate into and out of a wellbore can be critical to maintaining a desired pressure in the wellbore. Measurements of certain rheological properties of the fluid circulated through the wellbore, such as density and viscosity, are also needed for determination of pressure in the wellbore.

It will, therefore, be readily appreciated that improvements are continually needed in the art of flow rate and rheology measurement in well operations. The present disclosure provides such improvements, which may be utilized with a wide variety of different types of well operations, not limited to managed pressure drilling.

### BRIEF DESCRIPTION OF THE DRAWINGS

FIG. 1 is a representative partially cross-sectional view of an example of a well system and associated method which can embody principles of this disclosure.

FIG. 2 is a representative schematic view of an example of a flow measurement apparatus that may be used with the FIG. 1 system and method.

### DETAILED DESCRIPTION

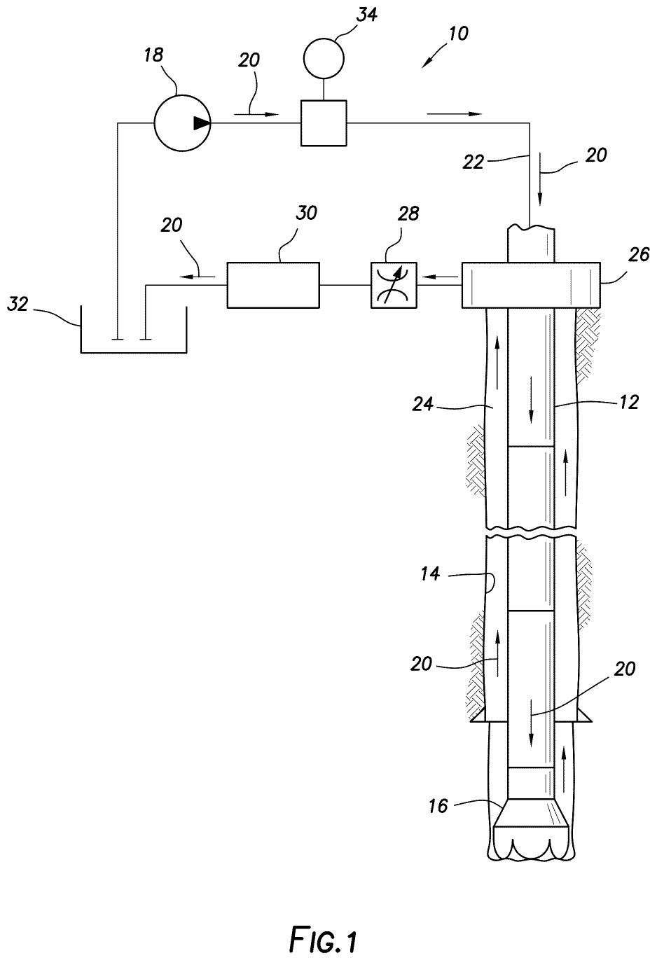

Representatively illustrated in FIG. 1 is a system 10 for use with a subterranean well, and an associated method, which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method as described herein and/or depicted in the drawings.

In the FIG. 1 example, a tubular string 12 is positioned in a wellbore 14. The tubular string 12 is a drill string having a drill bit 16 connected at a distal end thereof for the purpose of drilling into the earth. In other examples, the tubular string 12 could be a work string, a stimulation string, a completion string, an injection string, a production string, or another type of tubular string. The scope of this disclosure is not limited to use of any particular type of tubular string in a well, or to use of a tubular string at all.

As depicted in FIG. 1, a pump 18 is used to maintain a fluid flow 20 through the tubular string 12 in the wellbore 14. In this example, the fluid flow 20 enters the tubular string 12 at the surface via a standpipe 22, which may be connected to the tubular string via a top drive, a kelly, or other equipment (not shown). The fluid flow 20 exits the tubular string 12 in the wellbore 14 via nozzles (not shown) in the drill bit 16.

The fluid flow 20 returns to the surface via an annulus 24 formed between the tubular string 12 and the wellbore 14. In managed pressure drilling operations, the annulus 24 may be isolated from the atmosphere at the surface by well equipment 26 known to those skilled in the art as a rotating control device, rotating drilling head, rotating blowout preventer, rotating control head, etc. In well control operations, the well equipment 26 may be an annular blowout preventer, pipe rams, or other equipment. However, the scope of this disclosure is not limited to use of any well equipment to isolate an annulus from the atmosphere at the surface.

The returned fluid flow 20 may pass through a choke manifold 28 and various types of fluid conditioning equipment 30 (such as, a gas separator, a shale shaker, etc.) prior to flowing into a reservoir 32 (also known as a “mud pit”). The pump 18 draws fluid from the reservoir 32. Note that the FIG. 1 example is simplified for purposes of clarity of illustration and description, and those skilled in the art will appreciate that additional equipment or different equipment may be used, depending in part on the particular well operation being performed.

In the FIG. 1 example, a flow measurement apparatus 34 is connected between the pump 18 and the tubular string 12. Thus, the fluid flow 20 exiting the pump 18 passes through the flow measurement apparatus 34 and the standpipe 22 prior to entering the tubular string 12. In this manner, characteristics of the fluid flow 20 (such as, volumetric and mass flow rate, density, other rheological parameters, etc.) can be accurately measured as it is being introduced into the well. In some examples, another flow measurement apparatus (or another type of flow measurement apparatus) may also measure characteristics of the fluid flow 20 after it exits the well (such as, a flowmeter connected downstream of, or as part of, the choke manifold 28).

In the FIG. 1 example, the pump 18 may be of the type known as a triplex pump or rig pump. A flow rate produced by the pump 18 can in some cases be relatively high. In particular, the flow rate can be high enough to cause excessive wear and damage to a conventional mass flowmeter of the type that is designed to be connected in a main flow line (such as, downstream of the choke manifold 28).

The flow measurement apparatus 34 in the system 10 of FIG. 1 instead uses a mass flowmeter connected in a bypass flow passage, which is connected in parallel with a main flow passage. A flow restrictor in the bypass flow passage prevents the mass flowmeter from being exposed to undesirably high flow rates. This is especially beneficial in situations where the fluid flowing through the mass flowmeter has a relatively high density.

In addition, the flow measurement apparatus 34 includes features that provide for accurate flow measurement at relatively low flow rates. For example, it may be desired to be able to measure flow at a flow rate that is less than a “turn-down” flow rate below which a flowmeter (such as, a Coriolis flowmeter or another type of mass flowmeter) cannot accurately measure flow rate.

Thus, the unique features of the flow measurement apparatus 34 enable accurate flow measurement at a wide range of flow rates, from relatively high flow rates to relatively low flow rates. These unique features are described more fully below.

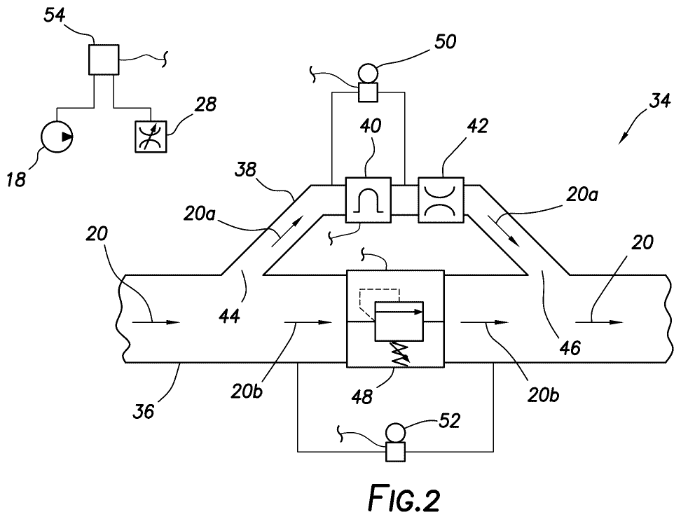

Referring additionally now to FIG. 2, a schematic view of an example of the flow measurement apparatus 34 is representatively illustrated. The FIG. 2 flow measurement apparatus 34 may be used with the system 10 and method of FIG. 1, or it may be used with other systems and methods. For convenience, the FIG. 2 apparatus 34 is described below as it may be used with the FIG. 1 system 10 and method.

In the FIG. 2 example, the flow measurement apparatus 34 includes a main flow passage 36 and a bypass flow passage 38 connected in parallel with a section of the main flow passage. A mass flowmeter 40 (such as, a Coriolis flowmeter) and a flow restrictor 42 are connected in the bypass flow passage 38.

A pressure relief choke or pressure relief valve 48 is connected in the main flow passage 36. As used herein, the term “pressure relief valve” is used to indicate either of those items of equipment known to those skilled in the art as a pressure relief valve or a pressure relief choke.

As described more fully below, the pressure relief valve 48 remains open when a flow rate through the main flow passage 36 is above a predetermined level, and the pressure relief valve closes to direct all of the fluid flow 20 to the bypass flow passage 38 when the flow rate drops below the predetermined flow rate level. The predetermined flow rate level in this example is a flow rate in the main flow passage 36 that corresponds to a flow rate in the bypass flow passage 38 that is greater than a turn-down (or minimum operable) flow rate of the mass flowmeter 40.

An inlet 44 of the bypass flow passage 38 is connected to the main flow passage 36 upstream of the pressure relief valve 48. An outlet 46 of the bypass flow passage 38 is connected to the main flow passage 36 downstream of the pressure relief valve 48. Thus, a portion 20a of the fluid flow 20 enters the bypass flow passage 38 via the inlet 44 upstream of the pressure relief valve 48, flows through the mass flowmeter 40 and the flow restrictor 42, and then flows back into the main flow passage 36 via the outlet 46 downstream of the pressure relief valve 48.

The pressure relief valve 48 in the main flow passage 36 produces a pressure drop from the inlet 44 to the outlet 46, thereby inducing the fluid flow portion 20a to flow through the bypass passage 38. However, where the density of the fluid is relatively high, it can be desirable to restrict the flow of the portion 20a through the mass flowmeter 40, in order to mitigate unacceptable wear or damage to the mass flowmeter.

The flow restrictor 42 is selected to have sufficient restriction to the fluid flow to prevent unacceptable wear or damage to the mass flowmeter 40. It is expected that unacceptable wear or damage to the mass flowmeter 40 can be avoided in actual well operations by maintaining a ratio of the flow rate of the main fluid flow portion 20b to the flow rate of the bypass fluid flow portion 20a greater than approximately 50:1. The flow restrictor 42 may be connected upstream or downstream of the mass flowmeter 40 in the bypass flow passage 38.

At low flow rates the pressure drop across the mass flowmeter 40 becomes much greater than the pressure drop across the flow restrictor 42. Thus, while the flow restrictor 42 significantly limits the flow rate of the bypass fluid flow portion 20a at relatively high flow rates, it has much less influence at relatively low flow rates. The proper sizing of the flow restrictor 42 and the pressure relief valve 48 allows measurements of rheological parameters of a wider range of fluids with varying density and viscosity to be made while improving the accuracy of measurements of the flow rate of the fluid flow 20.

In some examples, the flow restrictor 42 could comprise a variable flow restrictor (such as, the variable flow restrictors described in U.S. Pat. No. 11,702,896, the entire disclosure of which is incorporated herein by this reference for all purposes). If the flow rate of the fluid flow 20 in the main flow passage 36 increases, so that the flow rate of the fluid flow portion 20a through the mass flowmeter 40 would increase to an undesired level (e.g., resulting in unacceptable wear or damage to the mass flowmeter), a restriction to flow through the variable flow restrictor 42 can be increased to thereby reduce the proportion of the fluid flow 20 entering the bypass flow passage 38. Conversely, if the flow rate of the fluid flow 20 in the main flow passage 36 decreases, so that the flow rate of the fluid flow portion 20a through the mass flowmeter 40 would decrease to an undesired level (e.g., at an insufficient flow rate to produce accurate measurements), a restriction to flow through the variable flow restrictor 42 can be decreased to thereby increase the proportion of the fluid flowing through the bypass flow passage 38.

To aid in determining rheological parameters of the fluid flow 20, a differential pressure sensor 50 is connected across the mass flowmeter 40 and another differential pressure sensor 52 is connected across the pressure relief valve 48. The differential pressure sensor 50 senses a difference in pressure between an upstream side of the mass flowmeter 40 and a downstream side of the mass flowmeter. The differential pressure sensor 52 senses a difference in pressure between an upstream side of the pressure relief valve 48 and a downstream side of the pressure relief valve 48.

The sensor 50 facilitates determination of viscosity at the mass flowmeter 40. The sensor 52 facilitates determination of volumetric flow rate through the pressure relief valve 48, e.g., using the Bernoulli equation.

Although each of the sensors 50, 52 is depicted in FIG. 2 as being a single sensor, in other examples multiple sensors can be used. For example, the sensor 50 could be replaced by a pressure sensor connected upstream of the mass flowmeter 40 and another separate pressure sensor connected downstream of the mass flowmeter. Thus, the scope of this disclosure is not limited to any particular number or configuration of sensors in the flow measurement apparatus 34.

In the FIG. 2 example, the sensor 50 is connected to the bypass flow passage 38 upstream and downstream of the mass flowmeter 40. In other examples, the upstream side of the sensor 50 could be connected to the main flow passage 36 upstream of the inlet 44. Similarly, the sensor 52 is connected to the main flow passage 36 upstream and downstream of the pressure relief valve 48, but in other examples the upstream and/or downstream side of the sensor 52 could be connected to the bypass flow passage 38 or otherwise connected. The scope of this disclosure is not limited to any particular arrangement or connection of the various elements of the flow measurement apparatus 34.

The sensors 50, 52 can communicate pressure measurements to a control system 54 via any type of wired or wireless transmission. The control system 54 can be configured to control various aspects of a well operation. For example, in the FIG. 1 system 10 and method, the control system 54 could control operation of the pump 18 and/or the choke manifold 28 in response to outputs produced by the mass flowmeter 40 and the sensors 50, 52.

The control system 54 may include mathematical models, algorithms, adaptive learning, artificial intelligence, etc., for computing or determining various types of operational information (such as, bottom hole pressure) and rheological parameters (such as, density or the Herschel Bulkley fluid model parameters To, k and n), for example, as described in U.S. Pat. No. 11,661,805, the entire disclosure of which is hereby incorporated by reference for all purposes. In some examples, the mathematical models, algorithms, adaptive learning, artificial intelligence, etc., can be used to control operation of the pressure relief valve 48 to vary a flow rate (or pressure differential across the pressure relief valve) through the main flow passage 36 at which the pressure relief valve opens or closes.

As another example, an algorithm of the control system 54 can smooth the flow transition between the main flow passage 36 and the bypass flow passage 38 during opening or closing of the pressure relief valve 48. Measurement of flow rate can switch between the mass flowmeter 40 and differential pressure (as measured by the sensor 52), for example, in case of any unwanted signal noise in the mass flowmeter.

As another alternative, if there is a design requirement for flow rate measurement at a given periodic frequency of flow data transmission, the measurement can be paused between two measurement samples, timed precisely for movement of the gate or other closure member of the pressure relief valve 48, in order to provide enough time for the flow through the mass flowmeter 40 to stabilize. When opening or closing the pressure relief valve 48, it is expected that there will be some local fluctuations as fluid flow stabilizes (including, for example, u-tubing and/or pressure increasing and/or decreasing, and causing the density to vary slightly). The algorithm can hybridize between both flow measurements (i.e., based on the mass flowmeter 40 measurements, or based on the sensor 52 measurements), dynamically switching between whichever flow rate measurement is more accurate under the current conditions, or using a weighted average combination of flow rate measurements, and making volumetric shifts based on density fluctuations during the transition time.

The control system 54 may be used in some examples to close the pressure relief valve 48 in order to flush the bypass flow passage 38 with relatively high flow rates occasionally or periodically. This could be done whenever needed to remove accumulated solids from the bypass flow passage 38, or it could be done automatically each time the flow rate in the main flow passage 36 drops to less than a given level.

The control system 54 may be used in some examples to open the pressure relief valve 48 if the mass flowmeter 40 is blocked (such as, substantially restricted or fully plugged) or fails. For example, if the pressure relief valve 48 has been closed (e.g., at a relatively low flow rate), and there is an indication that the mass flowmeter 40 has become blocked (e.g., as indicated by the sensor 50 measurements) or is failing to provide accurate, usable measurements, the control system 54 can open the pressure relief valve 48, so that flow rate measurements are available using the sensor 52.

It may now be fully appreciated that the above disclosure provides significant advancements to the art of flow rate and rheology measurement in well operations. The flow measurement apparatus 34 described above provides for accurate flow measurement at a wide range of flow rates, from relatively high flow rates to relatively low flow rates. In one example, the flow measurements are taken at a relatively high pressure input side (e.g., upstream of the standpipe 22) in a managed pressure drilling operation.

The above disclosure provides to the art a flow measurement apparatus 34 for use with a subterranean well. In one example, the flow measurement apparatus 34 can comprise: a main flow passage 36, a pressure relief valve 48 connected in the main flow passage 36, a bypass flow passage 38 having an inlet 44 connected to the main flow passage 36 upstream of the pressure relief valve 48, and an outlet 46 connected to the main flow passage 36 downstream of the pressure relief valve 48, and a mass flowmeter 40 connected in the bypass flow passage 38 between the inlet 44 and the outlet 46.

The apparatus 34 may include a control system 54 connected to the pressure relief valve 48 and configured to close the pressure relief valve 48 in response to a flow rate in the main flow passage 36 being less than a predetermined flow rate level. The control system 54 may be configured to open the pressure relief valve 48 in response to an indication that the mass flowmeter 40 is blocked. The control system 54 may be configured to open the pressure relief valve 48 in response to a failure of the mass flowmeter 40.

The apparatus 34 may include at least one pressure sensor 52 configured to measure a pressure differential across the pressure relief valve 48. The apparatus 34 may include a control system 54 connected to the pressure relief valve 48 and configured to determine a flow rate in the main flow passage 36 based on the pressure differential.

The apparatus 34 may include a control system 54 connected to the pressure relief valve 48 and configured to determine a flow rate in the main flow passage 36 based on an output of the mass flowmeter 40.

The apparatus 34 may include a control system 54 connected to the pressure relief valve 48 and configured to determine a flow rate in the main flow passage 36 based on a combination of the pressure differential and an output of the mass flowmeter 40.

The control system 54 may be configured to vary the predetermined flow rate level.

The apparatus 34 may include a flow restrictor 42 connected in the bypass flow passage 38.

The above disclosure also provides to the art a method for use with a subterranean well. In one example, the method can comprise: connecting a flow measurement apparatus 34 in a well system 10, the flow measurement apparatus 34 comprising: a main flow passage 36, a pressure relief valve 48 connected in the main flow passage 36, a bypass flow passage 38 having an inlet 44 connected to the main flow passage 36 upstream of the pressure relief valve 48, and an outlet 46 connected to the main flow passage 36 downstream of the pressure relief valve 48, and a mass flowmeter 40 connected in the bypass flow passage 38 between the inlet 44 and the outlet 46; and closing the pressure relief valve 48 in response to a flow rate in the main flow passage 36 being less than a predetermined flow rate level.

The method may include opening the pressure relief valve 48 in response to the flow rate in the main flow passage 36 being greater than the predetermined flow rate level, in response to an indication that the mass flowmeter 40 is blocked, and/or in response to a failure of the mass flowmeter 40.

The method may include measuring a pressure differential across the pressure relief valve 48. The flow rate in the main flow passage 36 may be based on the pressure differential measuring step, based on an output of the mass flowmeter 40, and/or based on a combination of the pressure differential measuring and an output of the mass flowmeter 40.

The apparatus 34 may include a control system 54 that varies the predetermined flow rate level.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

1. A flow measurement apparatus for use with a subterranean well, the flow measurement apparatus comprising:
a main flow passage;
a pressure relief valve connected in the main flow passage;
a bypass flow passage having an inlet connected to the main flow passage upstream of the pressure relief valve, and an outlet connected to the main flow passage downstream of the pressure relief valve; and
a mass flowmeter connected in the bypass flow passage between the inlet and the outlet.

2. The apparatus of claim 1, further comprising a control system connected to the pressure relief valve and configured to close the pressure relief valve in response to a flow rate in the main flow passage being less than a predetermined flow rate level.

3. The apparatus of claim 2, in which the control system is further configured to open the pressure relief valve in response to: a) an indication that the mass flowmeter is blocked, or b) in response to a failure of the mass flowmeter.

4. (canceled)

5. The apparatus of claim 1, further comprising at least one pressure sensor configured to measure a pressure differential across the pressure relief valve.

6. The apparatus of claim 5, further comprising a control system connected to the pressure relief valve, and in which the control system is configured to determine a flow rate in the main flow passage based on: a) the pressure differential, b) an output of the mass flowmeter, or c) a combination of the pressure differential and an output of the mass flowmeter.

7. (canceled)

8. (canceled)

9. The apparatus of claim 2, in which the control system is configured to vary the predetermined flow rate level.

10. The apparatus of claim 1, in which the apparatus further comprises a flow restrictor connected in the bypass flow passage.

11. A method for use with a subterranean well, the method comprising:
connecting a flow measurement apparatus in a well system, the flow measurement apparatus comprising:
a main flow passage;
a pressure relief valve connected in the main flow passage;
a bypass flow passage having an inlet connected to the main flow passage upstream of the pressure relief valve, and an outlet connected to the main flow passage downstream of the pressure relief valve; and
a mass flowmeter connected in the bypass flow passage between the inlet and the outlet; and
closing the pressure relief valve in response to a flow rate in the main flow passage being less than a predetermined flow rate level.

12. The method of claim 11, further comprising opening the pressure relief valve in response to the flow rate in the main flow passage being greater than the predetermined flow rate level.

13. The method of claim 11, further comprising opening the pressure relief valve in response to an indication that the mass flowmeter is blocked.

14. The method of claim 11, further comprising opening the pressure relief valve in response to a failure of the mass flowmeter.

15. The method of claim 11, further comprising measuring a pressure differential across the pressure relief valve.

16. The method of claim 15, in which the flow rate in the main flow passage is based on: a) the pressure differential measuring, b) an output of the mass flowmeter, or c) a combination of the pressure differential measuring and an output of the mass flowmeter.

17. (canceled)

18. (canceled)

19. The method of claim 15, in which the apparatus further comprises a control system that varies the predetermined flow rate level.

20. The method of claim 11, in which the apparatus further comprises a flow restrictor connected in the bypass flow passage.
